(19) United States
(12) Patent Application Publication
(10) Pub. No.: US 2026/0038305 A1
(43) Pub. Date: Feb. 5, 2026

(54) DETERMINATION METHOD, NON-TRANSITORY COMPUTER-READABLE RECORDING MEDIUM, AND INFORMATION PROCESSING APPARATUS

(71) Applicant: Fujitsu Limited, Kawasaki-shi (JP)

(72) Inventor: Yoshihisa ASAYAMA, Kawasaki (JP)

(73) Assignee: Fujitsu Limited, Kawasaki-shi (JP)

(21) Appl. No.: 19/356,492

(22) Filed: Oct. 13, 2025

Related U.S. Application Data
(63) Continuation of application No. PCT/JP2023/016967, filed on Apr. 28, 2023.

(51) Int. Cl. G06V 40/20; A63B 24/00

(52) U.S. Cl. CPC G06V 40/23; A63B 24/0062; A63B 2024/0068; A63B 2220/05; A63B 2220/807; A63B 2230/62

(57) ABSTRACT

A determination method includes detecting a plurality of segment points based on a plurality of frames including a first feature amount indicating a feature amount related to a joint of a subject, integrating two or more segment points among the plurality of segment points, and adjusting a segment point to be integrated so that a second feature amount specified from the first feature amounts of a plurality of frames included in an integrated section of the segment points satisfies a condition of a feature amount of a predetermined basic motion, by using a processor.

### CROSS-REFERENCE TO RELATED APPLICATION

This application is a continuation of International Application No. PCT/JP2023/016967, filed on Apr. 28, 2023, the entire contents of which are incorporated herein by reference.

### FIELD

The embodiment discussed herein is related to a determination method and the like.

### BACKGROUND

In the field of gymnastics, a performance of a player is to be accurately evaluated. Until now, a plurality of referees have visually evaluated a performance of a player, but due to advancement of elements, it may be difficult to accurately evaluate the performance only by visual observance of the referees.

Therefore, a technique in the related art of automatically recognizing elements of a player is used. Hereinafter, an example of the related art is described. FIG. 15 is a diagram (1) illustrating an example of the related art. A device that executes processing of the related art is referred to as a “device of the related art”.

For example, the device of the related art measures distance information on a player using a 3D sensor and generates a time-series skeleton frame based on a measurement result. For example, three-dimensional coordinates of each of joints of the player are set in each skeleton frame. The device of the related art extracts a first feature amount from each skeleton frame. The first feature amount includes position information on a body part of the player, position information on the joints, information on joint angles, and the like.

In FIG. 15, description is made using time-series skeleton frames f1-1 to f1-16. The device of the related art detects states of the skeleton frames based on the first feature amounts of the skeleton frames f1-1 to f1-16. The state of the skeleton frame corresponds to a posture of the player illustrated by the skeleton frame. A relationship between the first feature amount and the state is defined in advance. When a state corresponding to a first feature amount does not exist, the state corresponding to the skeleton frame is set to “none”.

For example, the states of the skeleton frames f1-1 to f1-3 are set to “upright”. The state of the skeleton frames f1-9 to f1-11 is set to “handstand”. The state of the skeleton frames f1-15 to f1-16 is set to “upright”. The states of the rest of the skeleton frames are set to “none”.

The device of the related art detects skeleton frames to be segment points based on detection results of the state of each of the skeleton frames f1-1 to f1-16. For example, the device of the related art detects a skeleton frame in a specific state as a segment point. In the device of the related art, when skeleton frames in the specific state are continuous, a skeleton frame to be a segment point is detected using a predetermined condition. In the description of FIG. 15, the specific states are “upright” and “handstand”.

In the device of the related art, when the skeleton frames in the “upright” state are continuous, the skeleton frame in which an orientation of a spine is uppermost is detected as the segment point. For example, in the skeleton frames f1-1 to f1-3 in the “upright” state, when the skeleton frame in which the orientation of the spine is uppermost is the skeleton frame f1-2, the device of the related art detects the skeleton frame f1-2 as the segment point. In the skeleton frames f1-15 to f1-16 in the “upright” state, when the skeleton frame in which the orientation of the spine is uppermost is the skeleton frame f1-15, the device of the related art detects the skeleton frame f1-15 as the segment point.

In the device of the related art, when the skeleton frames in the “handstand” state are continuous, the skeleton frame in which the orientation of the spine is lowermost is detected as the segment point. For example, in the skeleton frames f1-9 to f1-11 in the “handstand” state, when the skeleton frame in which the orientation of the spine is lowermost is the skeleton frame f1-10, the device of the related art detects the skeleton frame f1-10 as the segment point.

The device of the related art detects the skeleton frames f1-2, f1-10, and f1-15 as segment points by executing the above processing.

The device of the related art classifies skeleton frames from an n-th segment point to an (n+1)-th segment point into the same group after detecting the segment points (n is a natural number). Based on the first feature amount included in the skeleton frames of the same group, the device of the related art calculates a second feature amount of the group. In the description of FIG. 15, the second feature amount includes a forward posture, a backward posture, salto, twist, and a highest point. The device of the related art identifies a basic motion corresponding to the group based on the second feature amount and a condition of a feature amount of the basic motion. The condition of the feature amount of the basic motion is set in advance.

For example, the device of the related art classifies the skeleton frames f1-2 to f1-10 included from the first segment point to the second segment point into a group G1. The device of the related art classifies the skeleton frames f1-10 to f1-15 included from the second segment point to the third segment point into a group G2.

The device of the related art compares the second feature amount calculated from the first feature amounts of the skeleton frames f1-2 to f1-10 classified into the group G1 with the condition of the feature amount of each basic motion and specifies the basic motion satisfying the condition of the feature amount. For example, when the second feature amount of the group G1 satisfies the condition of the feature amount of the basic motion “upright two foot take-off to backward handstand”, the device of the related art determines that the basic motion of the group G1 is “upright two foot take-off to backward handstand”. For example, the conditions of the feature amount of the basic motion “upright two foot take-off to backward handstand” are forward posture “upright”, backward posture “handstand”, salto “180°±90°”, twist “0°±90°”, and highest point “15 cm or more”.

Subsequently, the device of the related art compares the second feature amount calculated from the first feature amounts of the skeleton frames f1-10 to f1-15 classified into the group G2 with the condition of the feature amount of each basic motion and specifies the basic motion satisfying the condition of the feature amount. For example, when the second feature amount of the group G2 satisfies the condition of the feature amount of the basic motion “handstand to backward upright”, the device of the related art determines that the basic motion of the group G2 is “handstand to backward upright”. For example, the conditions of the feature amount of the basic motion “handstand to backward upright” are forward posture “handstand”, backward posture “upright”, salto “180°±90°”, and twist “0°±90°”, and highest point “15 cm or more”.

By executing the above processing, the device of the related art sequentially identifies the basic motion “upright two foot take-off to backward handstand” of the group G1 and the basic motion “handstand to backward upright” of the group G2. The device of the related art determines an element “back handspring” corresponding to a set of the basic motion “upright two foot take-off to backward handstand” and the basic motion “handstand to backward upright”.

FIG. 16 is a diagram (2) illustrating an example of the related art. In the example of FIG. 16, description is made using time-series skeleton frames f1-1 to f1-26. The device of the related art detects states of the skeleton frames based on the first feature amounts of the skeleton frames f1-1 to f1-26.

For example, the states of the skeleton frames f1-1 to f1-6 are referred to as “downward flair”. The states of the skeleton frames f1-21 to f1-26 are set to “downward flair”. The states of the rest of the skeleton frames are set to “none”.

The device of the related art detects skeleton frames to be segment points based on detection results of the state of each of the skeleton frames f1-1 to f1-26. The device of the related art detects a skeleton frame in a specific state as a segment point. In the device of the related art, when skeleton frames in the specific state are continuous, a skeleton frame to be a segment point is detected using a predetermined condition. In the description of FIG. 16, the specific state is “downward flair”.

In the device of the related art, when the skeleton frames in the “downward flair” state are continuous, a first skeleton frame in which both hands are on the floor is set as the segment point. For example, in the skeleton frames f1-1 to f1-6 in the “downward flair” state, when the first skeleton frame in which both hands are on the floor is the skeleton frame f1-2, the device of the related art detects the skeleton frame f1-2 as the segment point. In the skeleton frames f1-21 to f1-26 in the “downward flair” state, when the first skeleton frame in which both hands are on the floor is the skeleton frame f1-23, the device of the related art detects the skeleton frame f1-23 as the segment point.

The device of the related art detects the skeleton frames f1-2 and f1-23 as segment points by executing the above processing.

The device of the related art classifies skeleton frames from an n-th segment point to an (n+1)-th segment point into the same group after detecting the segment points. Based on the first feature amount included in the skeleton frames of the same group, the device of the related art calculates a second feature amount of the group. In the description of FIG. 16, the second feature amount includes a forward posture, a backward posture, flair, twist, and a split angle. The device of the related art identifies a basic motion based on the second feature amount and a condition of a feature amount of the basic motion. The condition of the feature amount of the basic motion is set in advance.

For example, the device of the related art classifies the skeleton frames f1-2 to f1-23 included from the first segment point to the second segment point into a group G1.

The device of the related art compares the second feature amount calculated from the first feature amounts of the skeleton frames f1-2 to f1-23 classified into the group G1 with the condition of the feature amount of each basic motion and specifies the basic motion satisfying the condition of the feature amount. For example, when the second feature amount of the group G1 satisfies the condition of the feature amount of the basic motion “split one flair half twist”, the device of the related art determines that the basic motion of the group G1 is “split one flair half twist”. For example, the conditions of the feature amount of the basic motion “split one flair half twist” are forward posture “downward flair”, backward posture “downward flair”, flair “360°±90°”, twist “180°±90°”, and split angle “60° or more”.

By executing the above processing, the device of the related art identifies the basic motion “split one flair half twist” of the group G1. The device of the related art determines an element “Flair with 1/2 spindle” corresponding to the basic motion “split one flair half twist”.

As described with reference to FIGS. 15 and 16, in the related art, the range of the skeleton frame corresponding to the basic motion is set based on the second feature amount of the group and the condition of the feature amount of each basic motion, and the element is determined from the combination of the basic motions.
Patent Literature 1: Japanese Laid-open Patent Publication No. 2020-38440

However, in the above-described related art, it is difficult to determine elements correctly. For example, in the related art, the range of the basic motion corresponding to the basic motion is set using the condition of the feature amount of the basic motion, whereby determination accuracy of the elements may be deteriorated.

### SUMMARY

According to an aspect of an embodiment, a determination method includes detecting a plurality of segment points based on a plurality of frames including a first feature amount indicating a feature amount related to a joint of a subject, integrating two or more segment points among the plurality of segment points, and adjusting a segment point to be integrated so that a second feature amount specified from the first feature amounts of a plurality of frames included in an integrated section of the segment points satisfies a condition of a feature amount of a predetermined basic motion, by using a processor.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a problem of the related art;

FIG. 2 is a diagram illustrating a simple solution for the related art;

FIG. 3 is a diagram illustrating a system according to the present embodiment;

FIG. 4 is a diagram (1) illustrating processing of an information processing apparatus according to the present embodiment;

FIG. 5 is a diagram (2) illustrating processing of the information processing apparatus according to the present embodiment;

FIG. 6 is a functional block diagram illustrating a configuration of the information processing apparatus according to the present embodiment;

FIG. 7 is a diagram illustrating an example of a human body model;

FIG. 8 is a diagram illustrating an example of joint names;

FIG. 9 is a diagram illustrating an example of a data structure of a segment point definition table;

FIG. 10 is a diagram illustrating an example of a data structure of a basic motion definition table;

FIG. 11 is a diagram illustrating an example of a data structure of an element definition table;

FIG. 12 is a flowchart illustrating a processing procedure of the information processing apparatus according to the present embodiment;

FIG. 13 is a diagram illustrating an example of another embodiment;

FIG. 14 is a diagram illustrating an example of a hardware configuration of a computer that implements functions similar to those of the information processing apparatus according to the embodiment;

FIG. 15 is a diagram (1) illustrating an example of the related art; and

FIG. 16 is a diagram (2) illustrating an example of the related art.

### DESCRIPTION OF EMBODIMENTS

Preferred embodiments of the present invention will be explained with reference to accompanying drawings. Note that the present invention is not limited by the embodiment.

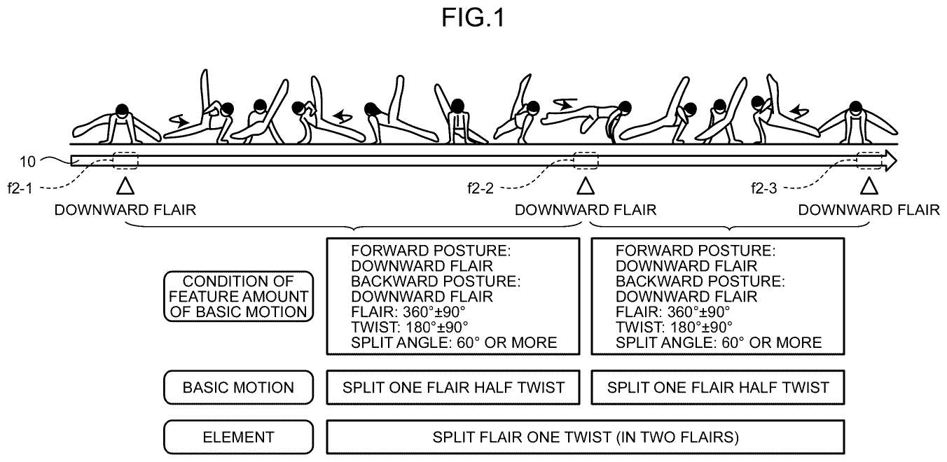

Before describing the present embodiment, problems of the related art are more specifically described. FIG. 1 is a diagram illustrating a problem of the related art. The device of the related art specifies a state of each skeleton frame based on a first feature amount of a time-series skeleton frame 10. The device of the related art detects a segment point based on the state of each skeleton frame. In FIG. 1, as an example, the states of skeleton frames f2-1, f2-2, and f2-3 are referred to as “downward flair”, and the skeleton frames f2-1 to f2-3 are each set as the segment point. Note that a plurality of skeleton frames included in the skeleton frames f2-1 to f2-2 and f2-2 to f2-3 are not illustrated. In the present embodiment, division of the time-series skeleton frames is referred to as “segment”, and a frame as a segment target is referred to as “skeleton frame to be a segment point”.

The device of the related art classifies skeleton frames from an n-th segment point to an (n+1)-th segment point into the same group after detecting the segment points. Based on the first feature amount included in the skeleton frames of the same group, the device of the related art calculates a second feature amount of the group. In the description of FIG. 1, the second feature amount includes a forward posture, a backward posture, flair, twist, and a split angle. The device of the related art identifies a basic motion based on the second feature amount and a condition of a feature amount of the basic motion. The condition of the feature amount of the basic motion is set in advance.

The device of the related art classifies the skeleton frames f2-1 and f2-2 included from the first segment point to the second segment point into a group G1. The device of the related art classifies the skeleton frames f2-2 to f2-3 included from the second segment point to the third segment point into a group G2.

The device of the related art compares the second feature amount calculated from the first feature amounts of the skeleton frames f2-1 to f2-2 classified into the group G1 with the condition of the feature amount of each basic motion and specifies the basic motion satisfying the condition of the feature amount. For example, when the second feature amount of the group G1 satisfies the condition of the feature amount of the basic motion “split one flair half twist”, the device of the related art determines that the basic motion of the group G1 is “split one flair half twist”. For example, the conditions of the feature amount of the basic motion “split one flair half twist” are forward posture “downward flair”, backward posture “downward flair”, flair “360°±90°”, twist “180°±90°”, and split angle “60° or more”.

Subsequently, the device of the related art compares the second feature amount calculated from the first feature amounts of the skeleton frames f2-2 to f2-3 classified into the group G2 with the condition of the feature amount of each basic motion and specifies the basic motion satisfying the condition of the feature amount. For example, when the second feature amount of the group G2 satisfies the condition of the feature amount of the basic motion “split one flair half twist”, the device of the related art determines that the basic motion of the group G2 is “split one flair half twist”.

By executing the above processing, the device of the related art sequentially identifies the basic motion “split one flair half twist” of the group G1 and the basic motion “split one flair half twist” of the group G2. The device of the related art determines the element “Flair with 1/1 spindle (in 2 circles)” for a set of the basic motion “split one flair half twist” and the basic motion “split one flair half twist”.

Here, in the gymnastics rule, the condition of flair (flair angle) of the element “Flair with 1/1 spindle (in 2 circles)” is “flair=630° to 810°”. However, in the related art, the element “Flair with 1/1 spindle (in 2 circles)” is determined from the combination of basic motions, and the element is not determined from the condition of the feature amount of the element itself. Therefore, even when the flairs in the skeleton frames f2-1 to f2-3 do not satisfy the condition of “630° to 810°”, it may be erroneously determined that the element “split flair one twist (in two flairs)” is established.

As illustrated in FIG. 1, the condition of flair of the basic motion “split one flair half twist” is “360°±90°”. For example, when the flair of the group G1 is “270°”, and the flair of the group G2 is “270°”, the total flair is “540°”, whereby the condition of flair of the gymnastics rule “flair=630° to 810°” is not satisfied. Similarly, when the flair of the group G1 is “450°”, and the flair of the group G2 is “450°”, the total flair is “900°”, whereby the condition of flair of the gymnastics rule “flair=630° to 810°” is not satisfied.

However, as described above, in the device of the related art, when the flair is included in “540° to 900°”, it may be erroneously determined that the element “Flair with 1/1 spindle (in 2 circles)” is established. For example, according to the gymnastics rule, even when the flair is “810°” or more and one twist is performed, the element “Flair with 1/1 spindle (in 2 circles)” is not acknowledged, but in the device of the related art, it is erroneously determined that the element “Flair with 1/1 spindle (in 2 circles)” is established.

Note that, as a simple solution to the problem of the related art illustrated in FIG. 1, when it is difficult to correctly determine an element by a combination of a plurality of basic motions, there is a method of determining the element by assuming that a plurality of basic motions are one basic motion.

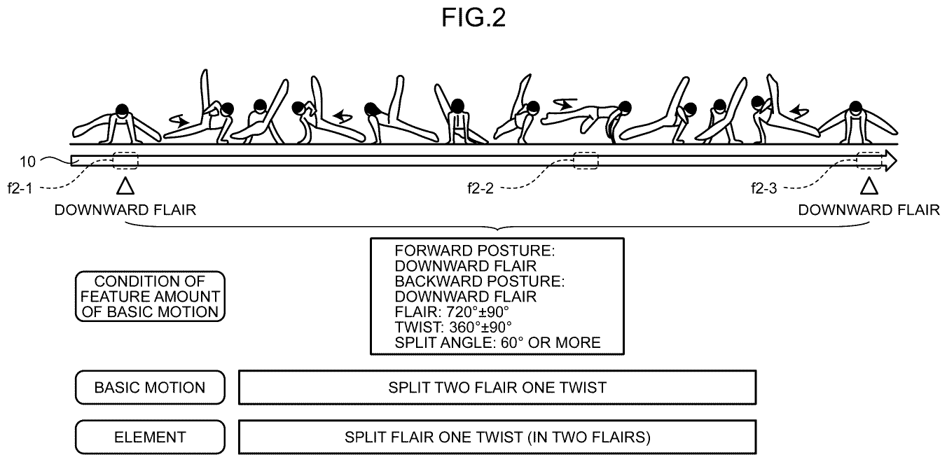

FIG. 2 is a diagram illustrating a simple solution for the related art. For easy description, a device that executes processing illustrated in FIG. 2 is referred to as “reference device”. The reference device specifies a state of each skeleton frame based on a first feature amount of the time-series skeleton frame 10. The reference device detects a segment point based on the state of each skeleton frame. In FIG. 2, as an example, the states of skeleton frames f2-1, f2-2, and f2-3 are referred to as “downward flair”, and the skeleton frames f2-1 to f2-3 are each set as the segment point. Note that a plurality of skeleton frames included in the skeleton frames f2-1 to f2-2 and f2-2 to f2-3 are not illustrated.

The reference device classifies the skeleton frames f2-1 to f2-3 from the first segment point to the last segment point into the same group G1 after detecting the segment points. The reference device calculates a second feature amount of the group G1 based on the first feature amount included in the skeleton frames of the group G1. In the description of FIG. 2, the second feature amount includes a forward posture, a backward posture, flair, twist, and a split angle. The reference device identifies the basic motion based on the second feature amount and a condition of a feature amount of the basic motion. The condition of the feature amount of the basic motion is set in advance.

The reference device compares the second feature amount calculated from the first feature amounts of the skeleton frames f2-1 to f2-3 classified into the group G1 with the condition of the feature amount of each basic motion and specifies the basic motion satisfying the condition of the feature amount. For example, when the second feature amount of the group G1 satisfies the condition of the feature amount of the basic motion “split two flair one twist”, the reference device determines that the basic motion of the group G1 is “split two flair one twist”. For example, the conditions of the feature amount of the basic motion “split two flair one twist” are forward posture “downward flair”, backward posture “downward flair”, flair “720°±90°”, twist “360°±90°”, and split angle “60° or more”.

By executing the above processing, the reference device identifies the basic motion “split two flair one twist” of the group G1. The reference device determines the element “Flair with 1/1 spindle (in 2 circles)” corresponding to the basic motion “split two flair one twist”.

According to the reference device described with reference to FIG. 2, since the condition of flair of the basic motion “split two flair one twist” coincides with the condition of the element “Flair with 1/1 spindle (in 2 circles)”, it is possible to correctly determine the element unlike the related art. However, a problem that it is not possible to identify each basic motion “split one flair half twist” that was identified in the related art occurs.

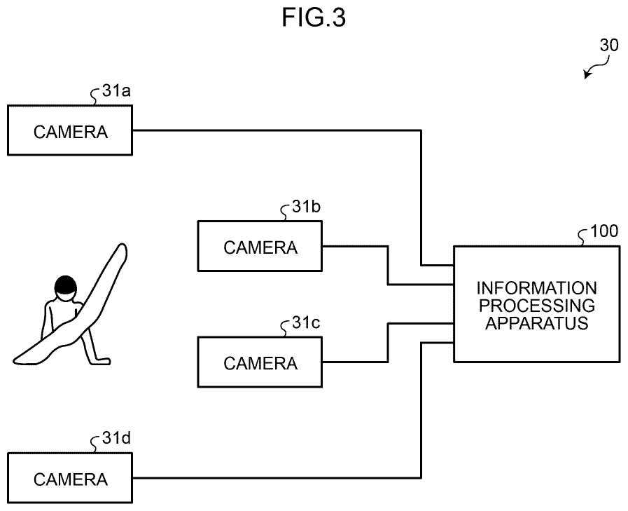

Next, the present embodiment is described. FIG. 3 is a diagram illustrating a system according to the present embodiment. As illustrated in FIG. 3, a system 30 includes cameras 31a, 31b, 31c, and 31d and an information processing apparatus 100. The cameras 31a to 31d are connected to the information processing apparatus 100 in a wired or wireless manner.

The cameras 31a to 31d are installed at different positions and capture images (red green blue (RGB) images) of a player. The cameras 31a to 31d transmit data of the captured images to the information processing apparatus 100. Data of the images captured by the cameras 31a to 31d are referred to as “image frames”. The cameras 31a to 31d transmit the plurality of image frames in time series to the information processing apparatus 100. A frame number is assigned to each image frame in the ascending order. In the following description, the cameras 31a to 31d are appropriately collectively referred to as “cameras 31”.

The information processing apparatus 100 has a trained skeleton inference model and generates time-series skeleton frames by inputting time-series image frames acquired from the cameras 31 to the skeleton inference model. For example, three-dimensional coordinates of each of joints of the player are set in each skeleton frame. The information processing apparatus 100 executes the following processing based on the time-series skeleton frames and determines the element of the player.

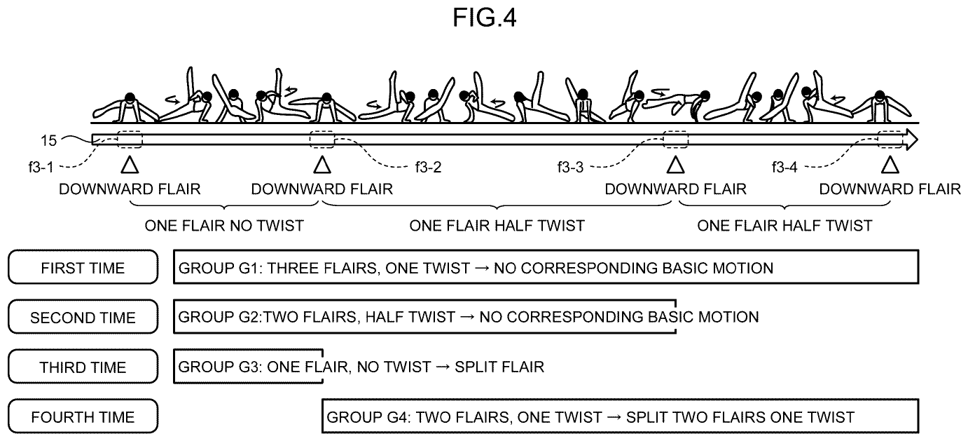

FIG. 4 is a diagram (1) illustrating processing of the information processing apparatus according to the present embodiment. The information processing apparatus 100 extracts the first feature amount from time-series skeleton frames 15. The first feature amount includes position information on a body part of the player, position information on the joints, information on joint angles, and the like. The information processing apparatus 100 specifies a state of each skeleton frame based on the first feature amount of the time-series skeleton frame 15. The information processing apparatus 100 detects a segment point based on the state of each skeleton frame. In FIG. 4, as an example, states of skeleton frames f3-1, f3-2, f3-3, and f3-4 are referred to as “downward flair”, and the skeleton frames f3-1 to f3-4 are each set as the segment point. In FIG. 4, the skeleton frames included in the skeleton frames f3-1 to f3-2, f3-2 to f3-3, and f3-3 to f3-4 are not illustrated.

After detecting the segment points, the information processing apparatus 100 integrates two or more segment points, and for the integrated segment points, classifies a plurality of skeleton frames included from a segment point that is a start point to a segment point that is an end point into the same group. The information processing apparatus 100 calculates a second feature amount of the group based on the first feature amount of each skeleton frame included in the same group. When the second feature amount of the group satisfies the condition of the feature amount of any basic motion, the information processing apparatus 100 associates the plurality of skeleton frames included in the current group with the basic motion. Meanwhile, when the second feature amount of the group does not satisfy the condition of the feature amount of any basic motion, the information processing apparatus 100 adjusts the segment points to be integrated and repeatedly executes the above processing.

When the states of the skeleton frames detected as the segment points are the same, the information processing apparatus 100 adjusts the segment points so that the skeleton frames are sequentially divided from the next segment point with reference to the first segment point. Meanwhile, when the states of the skeleton frames detected as the segment points are not the same, the information processing apparatus 100 adjusts the segment points so that the skeleton frames are sequentially divided from the previous segment point with reference to the last segment point.

In the example illustrated in FIG. 4, the state “downward flair” of the skeleton frames detected as the segment points is the same. Therefore, the information processing apparatus 100 adjusts the segment points so that the segment points are sequentially divided from the next segment point with reference to the first segment point.

First processing of the information processing apparatus 100 is described with reference to FIG. 4. The information processing apparatus 100 integrates segment points from a first segment point (frame f3-1) to a fourth segment point (frame f3-4) and classifies the skeleton frames included in the frames f3-1 to f3-4 into the same group G1. The information processing apparatus 100 calculates the second feature amount of the group G1 based on the first feature amount of the skeleton frame included in the group G1. For example, the second feature amounts of the group G1 are set to flair “1080° (three flairs)” and twist “360° (one twist)”.

The information processing apparatus 100 compares the second feature amount of the group G1 with the condition of the feature amount of each basic motion and determines whether the second feature amount of the group G1 satisfies the condition of the feature amount of any basic motion. Here, the description is continued assuming that the second feature amount of the group G1 does not satisfy the condition of the feature amount of any basic motion.

Second processing of the information processing apparatus 100 is described. Since the second feature amount of the group G1 does not satisfy the condition of the feature amount of any basic motion, the information processing apparatus 100 adjusts the segment points to be integrated. The information processing apparatus 100 integrates segment points from the first segment point (frame f3-1) to a third segment point (frame f3-3) and classifies the skeleton frames included in the frames f3-1 to f3-3 into the same group G2. The information processing apparatus 100 calculates the second feature amount of the group G2 based on the first feature amount of the skeleton frame included in the group G2. For example, the second feature amounts of the group G2 are set to flair “720° (two flairs)” and twist “180° (half twist)”.

The information processing apparatus 100 compares the second feature amount of the group G2 with the condition of the feature amount of each basic motion and determines whether the second feature amount of the group G2 satisfies the condition of the feature amount of any basic motion. Here, the description is continued assuming that the second feature amount of the group G2 does not satisfy the condition of the feature amount of any basic motion.

Third processing of the information processing apparatus 100 is described. Since the second feature amount of the group G2 does not satisfy the condition of the feature amount of any basic motion, the information processing apparatus 100 adjusts the segment points to be integrated. The information processing apparatus 100 integrates segment points from the first segment point (frame f3-1) to a second segment point (frame f3-2) and classifies the skeleton frames included in the frames f3-1 to f3-2 into the same group G3. The information processing apparatus 100 calculates the second feature amount of the group G3 based on the first feature amount of the skeleton frame included in the group G3. For example, the second feature amounts of the group G3 are set to flair “360° (one flair)” and twist “none”.

The information processing apparatus 100 compares the second feature amount of the group G3 with the condition of the feature amount of each basic motion and determines whether the second feature amount of the group G3 satisfies the condition of the feature amount of any basic motion. Here, it is assumed that the feature amount of the group G3 satisfies the condition of the feature amount of the basic motion “split flair”. Thus, the information processing apparatus 100 identifies the basic motion “split flair” corresponding to the group G3.

Fourth processing of the information processing apparatus 100 is described. The information processing apparatus 100 continues the processing on the skeleton frames f3-2 to f3-4 excluding the skeleton frames f3-1 to f3-2 classified into the group G3 among the skeleton frames f3-1 to f3-4. For example, the information processing apparatus 100 integrates segment points from the second segment point (frame f3-2) to the fourth segment point (frame f3-4) and classifies the skeleton frames included in the frames f3-2 to f3-4 into the same group G4. The information processing apparatus 100 calculates the second feature amount of the group G4 based on the first feature amount of the skeleton frame included in the group G4. For example, the second feature amounts of the group G4 are set to flair “720° (two flairs)” and twist “360° (one twist)”.

The information processing apparatus 100 compares the second feature amount of the group G4 with the condition of the feature amount of each basic motion and determines whether the second feature amount of the group G4 satisfies the condition of the feature amount of any basic motion. Here, it is assumed that the feature amount of the group G4 satisfies the condition of the feature amount of the basic motion “split two flairs one twist”. Thus, the information processing apparatus 100 identifies the basic motion “split two flairs one twist” corresponding to the group G4.

As described with reference to FIG. 4, the information processing apparatus 100 executes the first to fourth processing to identify the basic motion “split flair” and the basic motion “split flair one twist”. The information processing apparatus 100 determines the elements “1 flair” and “Flair with 1/1 spindle (in 2 circles)” corresponding to a set of the basic motion “split flair” and the basic motion “split two flairs one twist”. Note that, in FIG. 4, the case where the number of segment points is “four” is described, but the number of segment points is not limited to four.

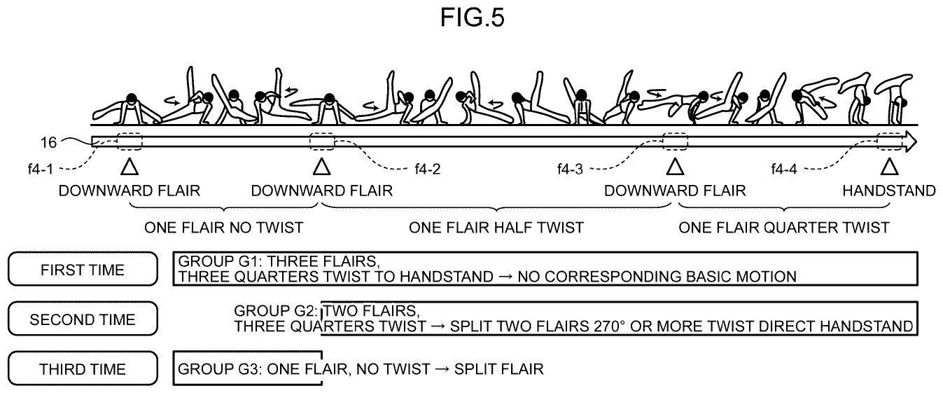

FIG. 5 is a diagram (2) illustrating processing of the information processing apparatus according to the present embodiment. The information processing apparatus 100 extracts the first feature amount from time-series skeleton frames 16. The information processing apparatus 100 specifies a state of each skeleton frame based on the first feature amount of the time-series skeleton frame 16. The information processing apparatus 100 detects a segment point based on the state of each skeleton frame. In FIG. 5, as an example, the states of skeleton frames f4-1, f4-2, and f4-3 are referred to as “downward flair”, and the skeleton frame f4-4 is referred to as “handstand”.

In the example illustrated in FIG. 5, since the states of the skeleton frame detected as the segment points are “downward flair” and “handstand”, the states are not the same. Therefore, the information processing apparatus 100 adjusts the segment points so that the segment points are sequentially divided from the previous segment point with reference to the last segment point.

First processing of the information processing apparatus 100 is described with reference to FIG. 5. The information processing apparatus 100 integrates segment points from the first segment point (frame f4-1) to the fourth segment point (frame f4-4) and classifies the skeleton frames included in the frames f4-1 to f4-4 into the same group G1. The information processing apparatus 100 calculates the second feature amount of the group G1 based on the first feature amount of the skeleton frame included in the group G1. For example, the second feature amounts of the group G1 are set to flair “1080° (three flairs)” and twist “270° (three quarters twist)” to handstand.

The information processing apparatus 100 compares the second feature amount of the group G1 with the condition of the feature amount of each basic motion and determines whether the second feature amount of the group G1 satisfies the condition of the feature amount of any basic motion. Here, the description is continued assuming that the second feature amount of the group G1 does not satisfy the condition of the feature amount of any basic motion.

Second processing of the information processing apparatus 100 is described. Since the second feature amount of the group G1 does not satisfy the condition of the feature amount of any basic motion, the information processing apparatus 100 adjusts the segment points to be integrated. The information processing apparatus 100 integrates segment points from the second segment point (frame f4-2) to the fourth segment point (frame f4-4) and classifies the skeleton frames included in the frames f4-2 to f4-4 into the same group G2. The information processing apparatus 100 calculates the second feature amount of the group G2 based on the first feature amount of the skeleton frame included in the group G2. For example, the second feature amounts of the group G2 are set to flair “720° (two flairs)” and twist “270° (three quarters twist)”.

The information processing apparatus 100 compares the second feature amount of the group G2 with the condition of the feature amount of each basic motion and determines whether the second feature amount of the group G2 satisfies the condition of the feature amount of any basic motion. Here, it is assumed that the feature amount of the group G2 satisfies the condition of the feature amount of the basic motion “split two flairs 270° or more twist direct handstand”. Thus, the information processing apparatus 100 identifies the basic motion “split two flairs 270° or more twist direct handstand” corresponding to the group G2.

Third processing of the information processing apparatus 100 is described. The information processing apparatus 100 continues the processing on the skeleton frames f4-1 to f4-2 excluding the skeleton frames f4-2 to f4-4 classified into the group G2 among the skeleton frames f4-1 to f4-4. For example, the information processing apparatus 100 integrates segment points from the first segment point (frame f4-1) to the second segment point (frame f4-2) and classifies the skeleton frames included in the frames f4-1 to f4-2 into the same group G3. The information processing apparatus 100 calculates the second feature amount of the group G3 based on the first feature amount of the skeleton frame included in the group G3. For example, the second feature amounts of the group G3 are set to flair “360° (one flair)” and no twist.

The information processing apparatus 100 compares the second feature amount of the group G3 with the condition of the feature amount of each basic motion and determines whether the second feature amount of the group G3 satisfies the condition of the feature amount of any basic motion. Here, it is assumed that the feature amount of the group G3 satisfies the condition of the feature amount of the basic motion “split flair”. Thus, the information processing apparatus 100 identifies the basic motion “split flair” corresponding to the group G3.

As described with reference to FIG. 5, the information processing apparatus 100 executes the first to third processing to identify the basic motion “split flair” and the basic motion “split two flairs 270° or more twist direct handstand”. The information processing apparatus 100 determines the elements “1 flair” and “Flair with >270° spindle (in 2 circles) directly to handstand” corresponding to a set of the basic motion “split flair” and the basic motion “split two flairs 270° or more twist direct handstand”.

As described above, the information processing apparatus 100 according to the present embodiment integrates two or more segment points, and for the integrated segment points, classifies a plurality of skeleton frames included from the segment point that is the start point to the segment point that is the end point into the same group. When the second feature amount of the same group satisfies the condition of the feature amount of any basic motion, the information processing apparatus 100 associates the plurality of skeleton frames included in the current group with the basic motion. Meanwhile, when the second feature amount of the group does not satisfy the condition of the feature amount of any basic motion, the information processing apparatus 100 adjusts the segment points to be integrated and repeatedly executes the above processing.

As a result, the basic motion of maximum units can be recognized, and determination accuracy of an element can be improved using the recognition result of the basic motion. For example, in a combination of basic motions in a section divided by minimum units of segment points, it is possible to accurately recognize an element that was not accurately recognized.

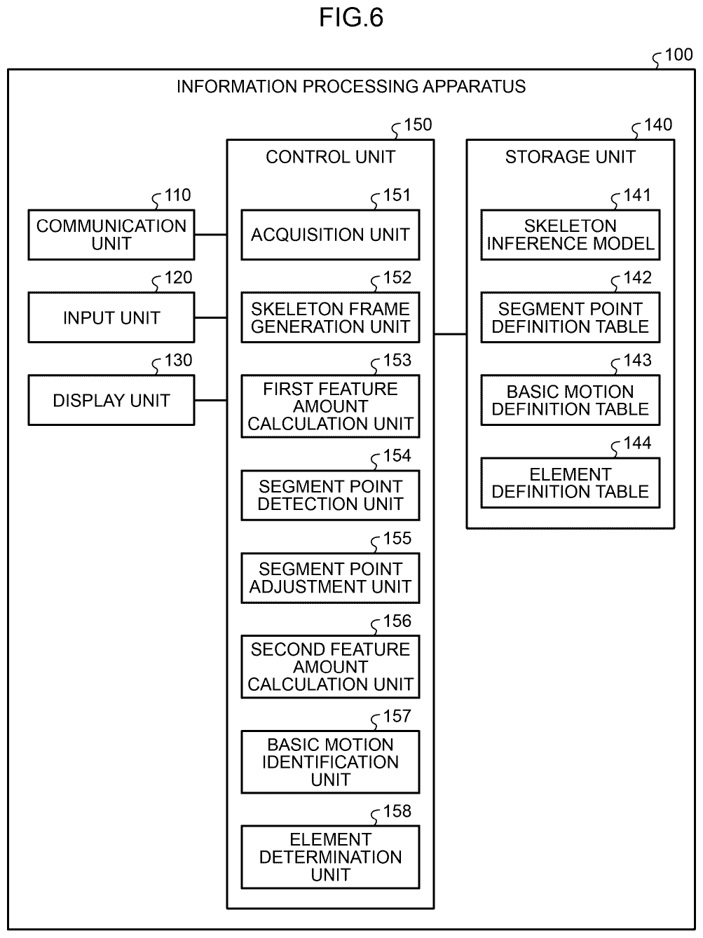

Next, a configuration example of the information processing apparatus 100 that executes the processing described with reference to FIGS. 4 and 5 is described. FIG. 6 is a functional block diagram illustrating a configuration of the information processing apparatus according to the present embodiment. As illustrated in FIG. 6, the information processing apparatus 100 includes a communication unit 110, an input unit 120, a display unit 130, a storage unit 140, and a control unit 150.

The communication unit 110 executes data communication with the cameras 31, external devices, and the like via a network. The communication unit 110 is a network interface card (NIC) or the like. For example, the communication unit 110 receives time-series image frames from the cameras 31.

The input unit 120 is an input device that inputs various types of information to the control unit 150 of the information processing apparatus 100. For example, the input unit 120 corresponds to a keyboard, a mouse, a touch panel, or the like.

The display unit 130 is a display device that displays information output from the control unit 150.

The storage unit 140 includes a skeleton inference model 141, a segment point definition table 142, a basic motion definition table 143, and an element definition table 144. The storage unit 140 is a storage device such as a memory.

The skeleton inference model 141 is a model that outputs skeleton frames of a player included in image frames captured by the cameras 31 when the image frames are input. The skeleton inference model 141 is a neural network (NN) or the like and is assumed to be already trained.

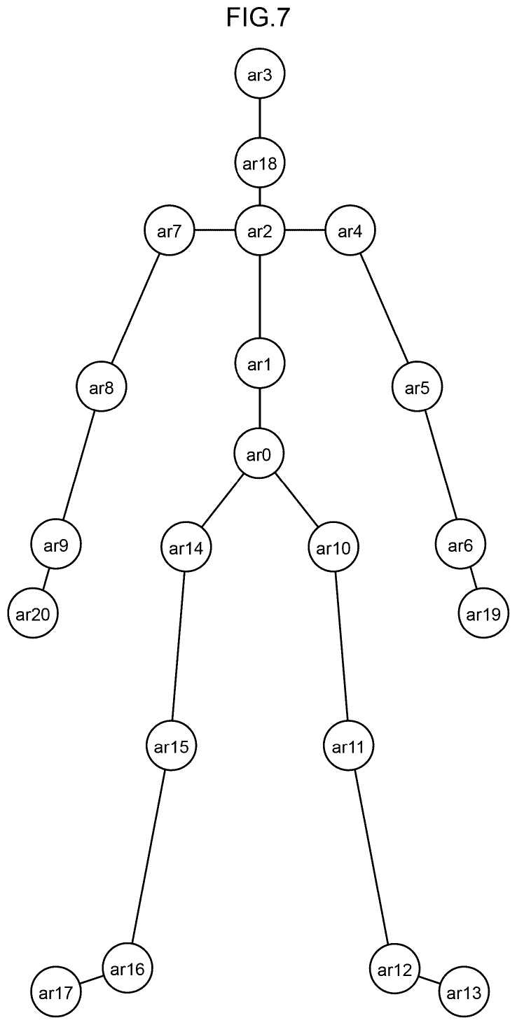

The skeleton frame is information in which three-dimensional coordinates are set for a plurality of joints defined by the human body model. FIG. 7 is a diagram illustrating an example of the human body model. As illustrated in FIG. 7, the human body model is defined by 21 joints ar0 to ar20.

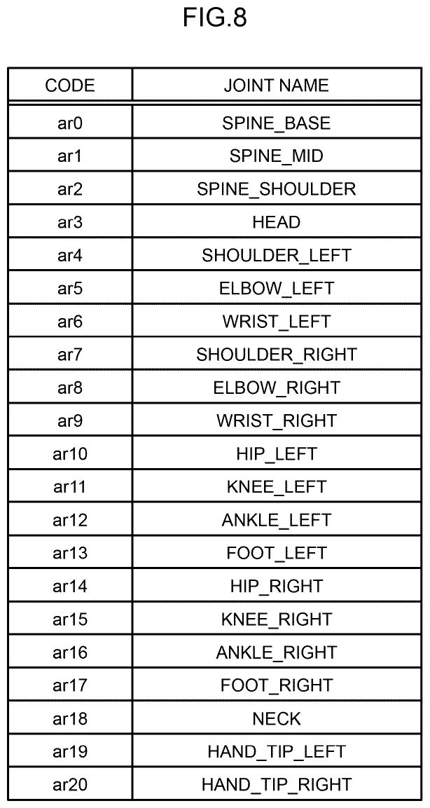

Relationships between the joints ar0 to ar20 are as illustrated in FIG. 7 and joint names are as illustrated in FIG. 8. FIG. 8 is a diagram illustrating an example of the joint names. For example, the joint name of the joint ar0 is “SPINE BASE”. The joint names of the joints ar1 to a20 are as illustrated in FIG. 8, and the description thereof is omitted.

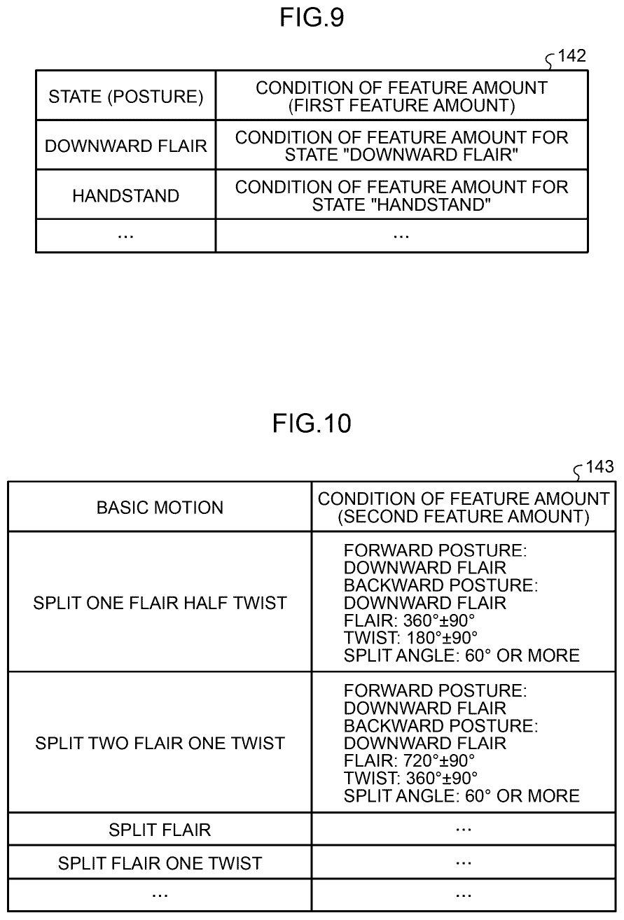

The description refers back to FIG. 6. The segment point definition table 142 is a table that defines a condition of a feature amount (first feature amount) of a skeleton frame detected as a segment point. FIG. 9 is a diagram illustrating an example of a data structure of the segment point definition table. As illustrated in FIG. 9, the segment point definition table 142 associates a state with a condition of the feature amount (first feature amount). The state corresponds to a posture of the player.

The basic motion definition table 143 is a table that defines a condition of a feature amount (second feature amount) of a basic motion. FIG. 10 is a diagram illustrating an example of a data structure of the basic motion definition table. As illustrated in FIG. 10, the basic motion definition table 143 associates a basic motion with a condition of the feature amount (second feature amount).

For example, the conditions of the feature amount of the basic motion “split one flair half twist” are forward posture “downward flair”, backward posture “downward flair”, flair “360°±90°”, twist “180°±90°”, and split angle “60° or more”. Here, the forward posture indicates a state of the segment point that is the start point of the plurality of integrated segment points. The backward posture indicates a state of the segment point that is the end point of the plurality of integrated segment points. Flair indicates a flair angle based on a spine vector of the player. For example, the spine vector indicates a vector from the joint ar0 to the joint ar2 in the human body model of FIG. 7. Twist indicates a twist angle based on the spine vector of the player. The split angle indicates an angle formed by a right leg vector and a left leg vector of the player. The right leg vector indicates a vector from the joint ar14 to the joint ar16 in the human body model of FIG. 7. The left leg vector indicates a vector from the joint ar10 to the joint ar12 in the human body model of FIG. 7.

Conditions of feature amounts of the basic motion “split two flairs one twist” are forward posture “downward flair”, backward posture “downward flair”, flair “720°±90°”, twist “360°±90°”, and split angle “60° or more”.

Although not illustrated, in the basic motion definition table 143, the conditions of the feature amounts are also set for the basic motion “split flair”, “split flair one twist”, and other basic motions.

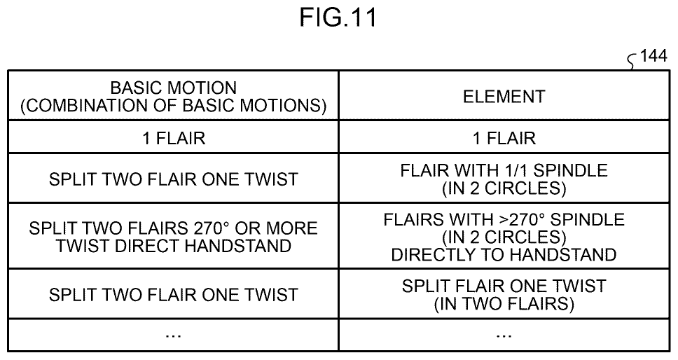

The element definition table 144 is a table that defines relationships between basic motions (or combinations of basic motions) and elements defined in the gymnastics rules. FIG. 11 is a diagram illustrating an example of a data structure of the element definition table. As illustrated in FIG. 11, the element definition table 144 associates a basic motion with an element. Even in the movement of the same player, names of basic motions and names of elements may be different. For example, an element corresponding to the basic motion “split flair” is “1 flair”. The element corresponding to the basic motion “split two flairs one twist” is “Flair with 1/1 spindle (in 2 circles)”.

The description of the control unit 150 in FIG. 6 is made. The control unit 150 includes an acquisition unit 151, a skeleton frame generation unit 152, a first feature amount calculation unit 153, a segment point detection unit 154, a segment point adjustment unit 155, a second feature amount calculation unit 156, a basic motion identification unit 157, and an element determination unit 158. The control unit 150 is a central processing unit (CPU), a graphics processing unit (GPU), or the like.

The acquisition unit 151 acquires time-series image frames from the camera 31. The acquisition unit 151 outputs the image frame to the skeleton frame generation unit 152.

The skeleton frame generation unit 152 generates the time-series skeleton frames by inputting time-series image frames to the skeleton inference model 141. The skeleton frame generation unit 152 outputs the time-series skeleton frames to the first feature amount calculation unit 153. The skeleton frame generation unit 152 may sequentially assign frame numbers to the time-series skeleton frames.

The first feature amount calculation unit 153 calculates a first feature amount for each skeleton frame in the time-series skeleton frames. That is, the first feature amount calculation unit 153 calculates one first feature amount from one skeleton frame. The first feature amount includes position information on a body part of the player, position information on the joints, information on joint angles, and the like.

The first feature amount calculation unit 153 outputs information in which the time-series skeleton frames are associated with the first feature amount to the segment point detection unit 154.

The segment point detection unit 154 detects a skeleton frame to be a segment point based on the first feature amount of the time-series skeleton frame and the segment point definition table 142. For example, the segment point detection unit 154 compares the condition of the feature amount of the segment point definition table 142 with the first feature amount of each skeleton frame and detects the skeleton frame corresponding to the first feature amount satisfying the condition of the feature amount as the segment point. When the segment point is detected, the segment point detection unit 154 also determines a state corresponding to the segment point.

When skeleton frames to be segment points are continuous, the segment point detection unit 154 detects a skeleton frame to be a segment point using a predetermined condition. For example, when the skeleton frames in which the state of the segment point is “downward flair” are continuous, the segment point detection unit 154 detects the first skeleton frame in which both hands are placed on the floor among the plurality of skeleton frames as the segment point. For example, the segment point detection unit 154 determines that both hands are placed on the floor when z (height) among the three-dimensional coordinates (x, y, z) of the joints ar19 and ar20 in FIG. 7 is less than a threshold.

The segment point detection unit 154 outputs the first feature amount of the time-series skeleton frames and the information on the segment point to the segment point adjustment unit 155. The information on the segment point is associated with the frame number of the skeleton frame to be the segment point and the state of the skeleton frame.

The segment point adjustment unit 155 integrates two or more segment points, and for the integrated segment points, classifies skeleton frames included from a start segment point to an end segment point into the same group. The segment point adjustment unit 155 outputs the first feature amount of each skeleton frame included in the same group to the second feature amount calculation unit 156.

Upon acquiring information indicating that the second feature amount of the group satisfies the condition of the feature amount of any basic motion from the basic motion identification unit 157, the segment point adjustment unit 155 confirms the integrated segment points and repeatedly executes the above processing on unprocessed segment points.

Upon acquiring information indicating that the second feature amount of the group does not satisfy the condition of the feature amount of any basic motion from the basic motion identification unit 157, the segment point adjustment unit 155 adjusts the integrated segment points and repeatedly executes the above processing.

Here, the processing of adjusting segment points by the segment point adjustment unit 155 is similar to the processing described in FIGS. 4 and 5. When the states of the skeleton frames detected as the segment points are the same, the segment point adjustment unit 155 adjusts the segment points so that the skeleton frames are sequentially divided from the next segment point with reference to the first segment point, as illustrated in FIG. 4. For example, the segment point adjustment unit 155 performs adjustment of excluding the segment point that is the end point from integration targets among the integrated segment points.

Meanwhile, when the states of the skeleton frames detected as the segment points are not the same, the information processing apparatus 100 adjusts the segment points so that the skeleton frames are sequentially divided from the previous segment point with reference to the last segment point, as illustrated in FIG. 5. For example, the segment point adjustment unit 155 performs adjustment of excluding the segment point that is the start point from integration targets among the integrated segment points.

The second feature amount calculation unit 156 calculates the second feature amount of the group based on the first feature amount of each skeleton frame included in the same group. For example, the second feature amount includes a forward posture, a backward posture, flair, twist, and a split angle. The second feature amount calculation unit 156 sets the state of the segment point (skeleton frame) that is the start point of the skeleton frames included in the group as the forward posture. The second feature amount calculation unit 156 sets the state of the segment point (skeleton frame) that is the end point of the skeleton frames included in the group as the backward posture.

The second feature amount calculation unit 156 specifies spine vectors of the skeleton frames included in the group and calculates a change in angle of the spine vector related to the flair from the start point to the end point as the flair (flair angle).

The second feature amount calculation unit 156 specifies the spine vectors of the skeleton frames included in the group and calculates a change in angle of the spine vector related to the twist from the start point to the end point as the twist (twist angle).

The second feature amount calculation unit 156 specifies the right leg vectors and the left leg vectors of the skeleton frames included in the group and calculates an angle formed by the right leg vector and the left leg vector. The second feature amount calculation unit 156 calculates the angle formed by the right leg vector and the left leg vector for each skeleton frame and calculates the maximum value of the formed angle as the split angle.

The second feature amount calculation unit 156 calculates the second feature amount of the group by executing the above processing and outputs the second feature amount of the group to the basic motion identification unit 157. Note that the second feature amount calculation unit 156 may calculate the second feature amount using another well-known technique. The second feature amount calculation unit 156 may calculate a feature amount other than a forward posture, a backward posture, flair, twist, and a split angle as the second feature amount.

The basic motion identification unit 157 identifies a basic motion corresponding to the group based on the second feature amount of the group and the condition of the feature amount of the basic motion definition table 143. When the second feature amount of the group satisfies the condition of any feature amount of the basic motion definition table 143, the basic motion identification unit 157 identifies the basic motion corresponding to the condition of the feature amount. For example, when the second feature amount of the group satisfies the condition of the feature amount of the basic motion “split one flair half twist”, the basic motion identification unit 157 identifies that the basic motion illustrated by the skeleton frame of the group is “split one flair half twist”.

Meanwhile, when the second feature amount of the group does not satisfy the condition of any feature amount in the basic motion definition table 143, the basic motion identification unit 157 determines that the basic motion corresponding to the second feature amount of the group does not exist.

The basic motion identification unit 157 outputs the identification result to the segment point adjustment unit 155. The basic motion identification unit 157 outputs information on the identified basic motion to the element determination unit 158.

The element determination unit 158 determines an element based on the basic motion identified by the basic motion identification unit 157 and the element definition table 144. The element determination unit 158 displays the element determination result on the display unit 130.

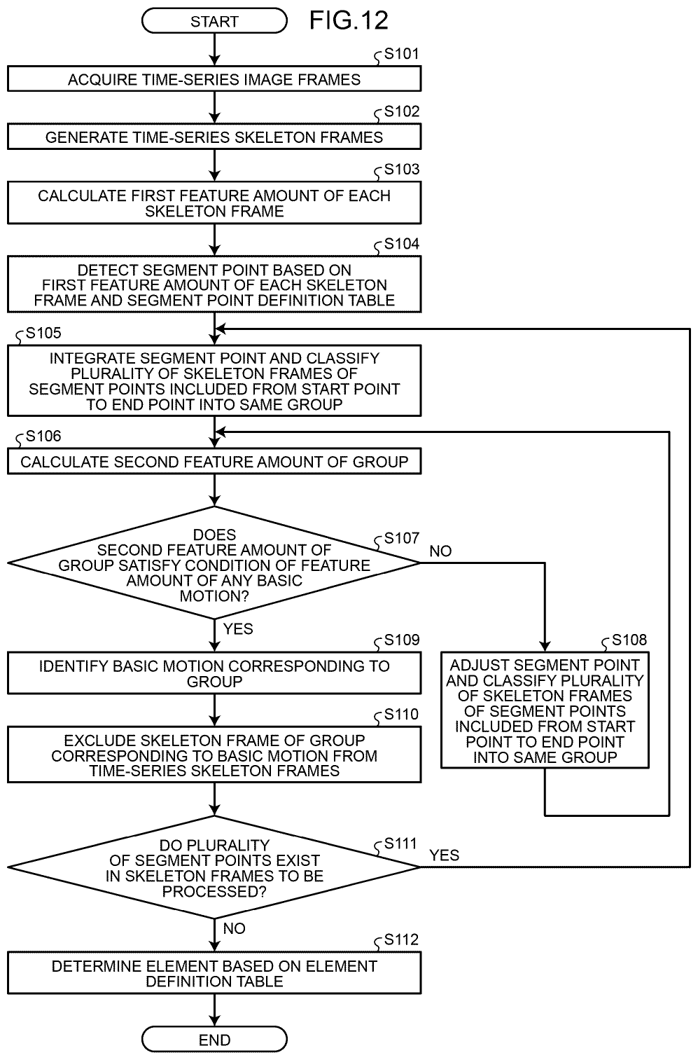

Next, a processing procedure of the information processing apparatus 100 according to the present embodiment is described. FIG. 12 is a flowchart illustrating a processing procedure of the information processing apparatus according to the present embodiment. As illustrated in FIG. 12, the acquisition unit 151 of the information processing apparatus 100 acquires the time-series image frames from the cameras 31 (step S101). The time-series skeleton frames are generated by inputting the time-series image frames of the information processing apparatus 100 to the skeleton inference model 141 (step S102).

The first feature amount calculation unit 153 of the information processing apparatus 100 calculates the first feature amount of each skeleton frame (step S103). The segment point detection unit 154 of the information processing apparatus 100 detects a segment point based on the first feature amount of the skeleton frame and the segment point definition table 142 (step S104).

The segment point adjustment unit 155 of the information processing apparatus 100 integrates the segment points and classifies the plurality of skeleton frames of the segment points included from the start point to the end point into the same group (step S105). The second feature amount calculation unit 156 of the information processing apparatus 100 calculates the second feature amount of the group (step S106).

Based on the basic motion definition table 143, when the second feature amount of the group does not satisfy the condition of the feature amount of any basic motion (Step S107, No), the basic motion identification unit 157 of the information processing apparatus 100 proceeds to step S108. Meanwhile, based on the basic motion definition table 143, when the second feature amount of the group satisfies the condition of the feature amount of any basic motion (Step S107, Yes), the basic motion identification unit 157 proceeds to step S109.

The segment point adjustment unit 155 adjusts the segment points, classifies the plurality of skeleton frames included of the segment points from the start point to the end point into the same group (step S108), and proceeds to step S106.

The basic motion identification unit 157 identifies the basic motion corresponding to the group (step S109). The segment point adjustment unit 155 excludes the skeleton frames of the group corresponding to the basic motion from the time-series skeleton frames (step S110).

When a plurality of segment points exist in the skeleton frames to be processed (Step S111, Yes), the segment point adjustment unit 155 proceeds to step S105. Meanwhile, when a plurality of segment points does not exist in the skeleton frames to be processed (Step S111, No), the element determination unit 158 of the information processing apparatus 100 determines the element based on the element definition table 144 (step S112).

Next, an effect of the information processing apparatus 100 according to the present embodiment is described. The information processing apparatus 100 integrates two or more segment points, and for the integrated segment points, classifies the plurality of skeleton frames included from the segment point that is the start point to the segment point that is the end point into the same group. When the second feature amount of the same group satisfies the condition of the feature amount of any basic motion, the information processing apparatus 100 associates the plurality of skeleton frames included in the current group with the basic motion. Meanwhile, when the second feature amount of the group does not satisfy the condition of the feature amount of any basic motion, the information processing apparatus 100 adjusts the segment points to be integrated and repeatedly executes the above processing.

As a result, the basic motion of maximum units can be recognized, and determination accuracy of an element can be improved using the recognition result of the basic motion. For example, in a combination of basic motions in a section divided by minimum units of segment points, it is possible to accurately determine an element that was not accurately recognized.

The information processing apparatus 100 determines the element based on the basic motion and the element definition table 144. As a result, an element of the player can be accurately determined.

When the postures of the integrated segment points are the same during adjustment of the integrated segment points, the information processing apparatus 100 performs adjustment of excluding the segment point that is the end point of the integrated segment points from the integration targets. When the postures of the integrated segment points are different, the information processing apparatus 100 performs adjustment of excluding the segment point that is the start point of the integrated segment points from the integration targets. Accordingly, it is possible to accurately recognize maximum units of the basic motion.

Meanwhile, as an example in the present embodiment, the information processing apparatus 100 acquires time-series image frames from the cameras 31 and generates time-series skeleton frames, but the present invention is not limited thereto. For example, the information processing apparatus 100 may measure a distance image of a player using a 3D sensor and generate time-series skeleton frames based on the measurement result.

In the processing of the information processing apparatus 100 according to the present embodiment, the skeleton frame is detected as the segment point when the state of the skeleton frame becomes a specific state such as “downward flair” focusing on gymnastics competitions, but the present invention is not limited thereto.

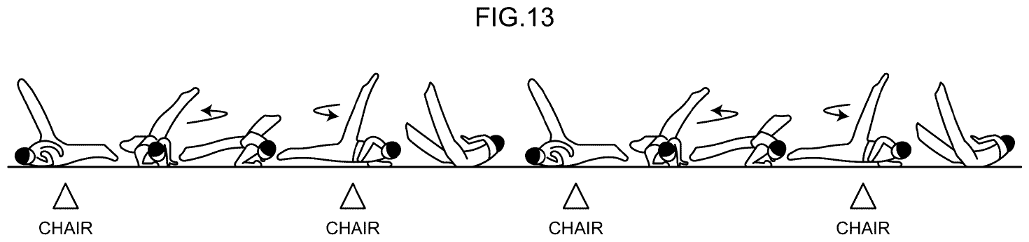

FIG. 13 is a diagram illustrating an example of another embodiment. The information processing apparatus 100 can also detect a skeleton frame of a segment point for a player performing breakdancing. For example, in an element called windmill, a player repeatedly turns in a posture called “chair”. The information processing apparatus 100 detects a skeleton frame corresponding to the posture of the chair among time-series skeleton frames as a segment point. The processing after the information processing apparatus 100 detects the segment point is similar to the above processing.

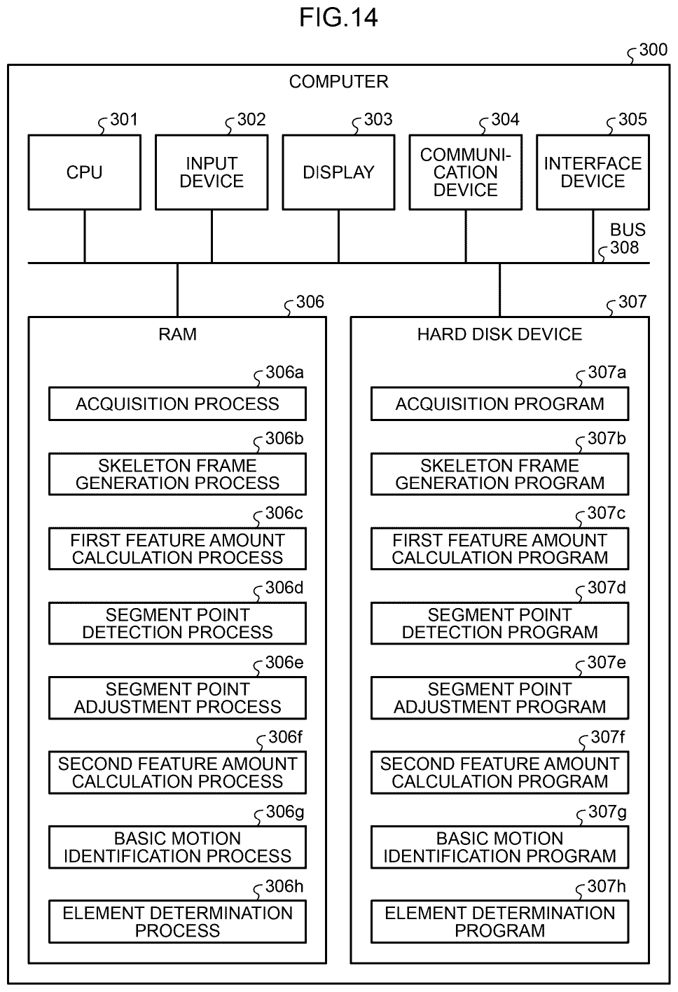

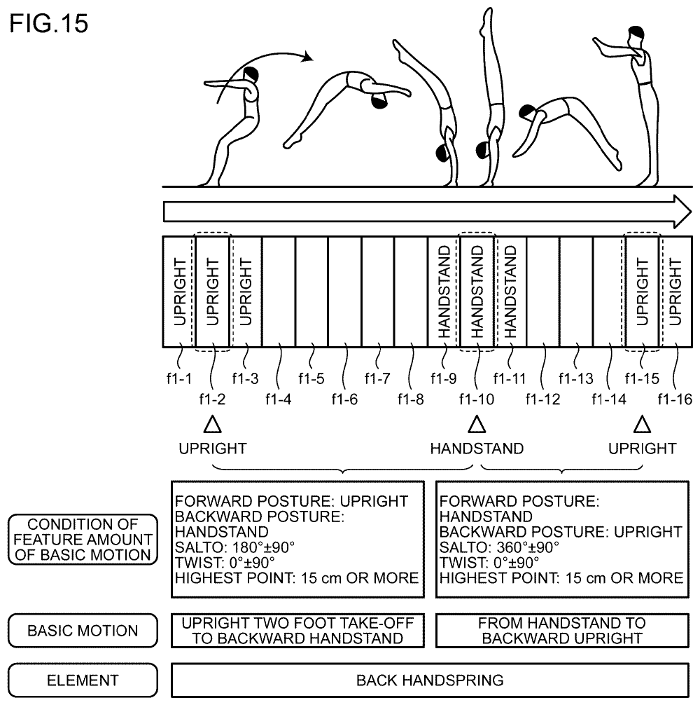

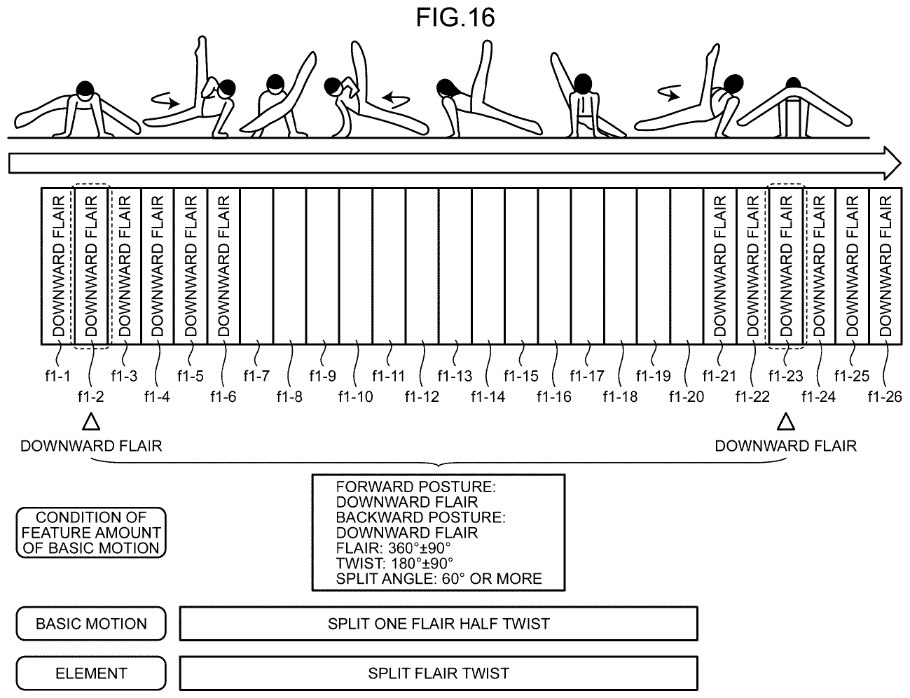

Next, an example of a hardware configuration of a computer that implements functions similar to those of the information processing apparatus 100 described above is described. FIG. 14 is a diagram illustrating an example of a hardware configuration of the computer that implements functions similar to those of the information processing apparatus according to the embodiment.

As illustrated in FIG. 14, a computer 300 includes a CPU 301 that executes various types of arithmetic processing, an input device 302 that receives an input of data from a user, and a display 303. The computer 300 includes a communication device 304 that transmits and receives data to and from external devices or the like via a wired or wireless network, and an interface device 305. The computer 300 includes a RAM 306 that temporarily stores various types of information, and a hard disk device 307. The devices 301 to 307 are each connected to a bus 308.

The hard disk device 307 includes an acquisition program 307a, a skeleton frame generation program 307b, a first feature amount calculation program 307c, and a segment point detection program 307d. The hard disk device 307 includes a segment point adjustment program 307e, a second feature amount calculation program 307f, a basic motion identification program 307g, and an element determination program 307h. The CPU 301 reads the programs 307a to 307h and loads the programs on the RAM 306.

The acquisition program 307a functions as an acquisition process 306a. The skeleton frame generation program 307b functions as a skeleton frame generation process 306b. The first feature amount calculation program 307c functions as a first feature amount calculation process 306c. The segment point detection program 307d functions as a segment point detection process 306d. The segment point adjustment program 307e functions as a segment point adjustment process 306e. The second feature amount calculation program 307f functions as a second feature amount calculation process 306f. The basic motion identification program 307g functions as a basic motion identification process 306g. The element determination program 307h functions as an element determination process 306h.

Processing of the acquisition process 306a corresponds to processing of the acquisition unit 151. Processing of the skeleton frame generation process 306b corresponds to processing of the skeleton frame generation unit 152. Processing of the first feature amount calculation process 306c corresponds to processing of the first feature amount calculation unit 153. Processing of the segment point detection process 306d corresponds to processing of the segment point detection unit 154. Processing of the segment point adjustment process 306e corresponds to processing of the segment point adjustment unit 155. Processing of the second feature amount calculation process 306f corresponds to processing of the second feature amount calculation unit 156. Processing of the basic motion identification process 306 corresponds to processing of the basic motion identification unit 157. Processing of the element determination process 306h corresponds to processing of the element determination unit 158.

Note that the programs 307a to 307h may be stored on devices other than the hard disk device 307 from the beginning. For example, the programs are stored in “portable physical medium” such as a flexible disk (FD), a CD-ROM, a DVD, a magneto-optical disk, or an IC card that can be inserted into the computer 300. Then, the computer 300 may read and execute the programs 307a to 307h.

Determination accuracy of an element can be improved.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A determination method comprising:
detecting a plurality of segment points based on a plurality of frames including a first feature amount indicating a feature amount related to a joint of a subject;
integrating two or more segment points among the plurality of segment points; and
adjusting a segment point to be integrated so that a second feature amount specified from the first feature amounts of a plurality of frames included in an integrated section of the segment points satisfies a condition of a feature amount of a predetermined basic motion, by using a processor.

2. The determination method according to claim 1, further including adjusting the segment point to be integrated so that the second feature amount satisfies a condition of a feature amount of a basic motion including one or more flairs.

3. The determination method according to claim 1, further including determining an element based on a basic motion corresponding to the integrated segment point.

4. The determination method according to claim 1, further including:
detecting a posture of the subject based on the first feature amount of a frame corresponding to the segment point, and
when postures of the integrated segment points are the same postures, excluding a segment point that is an end point among the integrated segment points from integration targets.

5. The determination method according to claim 4, further including, when postures of the integrated segment points are different postures, excluding a segment point that is a start point among the integrated segment points from integration targets.

6. A non-transitory computer-readable recording medium having stored therein a determination program that causes a computer to execute a process comprising:
detecting a plurality of segment points based on a plurality of frames including a first feature amount indicating a feature amount related to a joint of a subject;
integrating two or more segment points among the plurality of segment points; and
adjusting a segment point to be integrated so that a second feature amount specified from the first feature amounts of a plurality of frames included in an integrated section of the segment points satisfies a condition of a feature amount of a predetermined basic motion.

7. The non-transitory computer-readable recording medium according to claim 6, wherein the process further includes adjusting the segment point to be integrated so that the second feature amount satisfies a condition of a feature amount of a basic motion including one or more flairs.

8. The non-transitory computer-readable recording medium according to claim 6, wherein the process further includes determining an element based on a basic motion corresponding to the integrated segment point.

9. The non-transitory computer-readable recording medium according to claim 6, wherein the process further includes:
detecting a posture of the subject based on the first feature amount of a frame corresponding to the segment point, and
when postures of the integrated segment points are the same postures, excluding a segment point that is an end point among the integrated segment points from integration targets.

10. The non-transitory computer-readable recording medium according to claim 9, wherein the process further includes, when postures of the integrated segment points are different postures, excluding a segment point that is a start point among the integrated segment points from integration targets.

11. An information processing apparatus comprising:
a memory; and
a processor coupled to the memory and configured to:
detect a plurality of segment points based on a plurality of frames including a first feature amount indicating a feature amount related to a joint of a subject;
integrate two or more segment points among the plurality of segment points; and
adjust a segment point to be integrated so that a second feature amount specified from the first feature amounts of a plurality of frames included in an integrated section of the segment point satisfies a condition of a feature amount of a predetermined basic motion.

12. The information processing apparatus according to claim 11, wherein the processor is further configured to adjust the segment point to be integrated so that the second feature amount satisfies a condition of a feature amount of a basic motion including one or more flairs.

13. The information processing apparatus according to claim 11, wherein the processor is further configured to determine an element based on a basic motion corresponding to the integrated segment point.

14. The information processing apparatus according to claim 11, wherein the processor is further configured to:
detect a posture of the subject based on the first feature amount of a frame corresponding to the segment point, and
when postures of the integrated segment points are the same postures, exclude a segment point that is an end point among the integrated segment points from integration targets.

15. The information processing apparatus according to claim 14, wherein the processor is further configured to, when postures of the integrated segment points are different postures, exclude a segment point that is a start point among the integrated segment points from integration targets.
